(19) United States
(12) Patent Application Publication
(10) Pub. No.: US 2026/0231976 A1
(43) Pub. Date: Aug. 13, 2026

(54) GUMMY CANDY PRODUCTION SYSTEM AND METHOD

(71) Applicant: JIANGSU AIFOCUS HEALTH TECHNOLOGY CO., LTD, Jingjiang City, Taizhou, Jiangsu (CN)

(72) Inventors: Guodong ZHANG, Jingjiang City, Taizhou, Jiangsu (CN); Zhongke CHEN, Jingjiang City, Taizhou, Jiangsu (CN); Xudong XIA, Jingjiang City, Taizhou, Jiangsu (CN); Xing ZHANG, Jingjiang City, Taizhou, Jiangsu (CN); Lei SHU, Jingjiang City, Taizhou, Jiangsu (CN); Qing ZHU, Jingjiang City, Taizhou, Jiangsu (CN); Hui HUANG, Jingjiang City, Taizhou, Jiangsu (CN)

(21) Appl. No.: 19/472,203

(22) PCT Filed: Sep. 25, 2023
(86) PCT No.: PCT/CN2023/120959

§ 371 Date: Oct. 3, 2025

(30) Foreign Application Priority Data
Jul. 26, 2023 (CN) 202310926359.0

(51) Int. Cl. A23G 3/02; A23G 3/20; A23G 3/34

(52) U.S. Cl. CPC A23G 3/0247; A23G 3/0014; A23G 3/0031; A23G 3/0215; A23G 3/0257; A23G 3/2092; A23G 3/34

(57) ABSTRACT

Disclosed is a gummy candy production system and method, where the gummy candy production system includes a slurry preparation system (1) for dispersing, dissolving, and shear-mixing continuously supplied materials for preparing a gummy slurry to form a homogeneous gummy slurry; a continuous deaeration system (2) for receiving and continuously deaerating the gummy slurry; a flat sheet pouring system (3) for processing the gummy slurry into candy bodies in a fixed shape; an automatic cutting system (4) for cutting the candy bodies into candy pieces in a preset size; a drying system (5) for continuously drying and discharging the candy pieces; an oil coating and packaging system (6) for coating the candy pieces with oil and packaging oil-coated candy pieces; and a control system (7) for receiving a product production information instruction and automatically retrieving production process parameters of the systems. By employing a continuous production process, the above method requires less equipment, consumes less energy, and provides higher production efficiency at the same production scale.

### TECHNICAL FIELD

The present invention relates to the technical field of food processing, and in particular, to a gummy candy production system and method.

### BACKGROUND

As a food form, gummy candies are very popular in the market and definitely considered a star in the health nutrition and dietary supplement industry. Their soft and cute appearance appeals to consumers of different ages, especially children and young adults. Importantly, as a newly approved dosage form for dietary supplements, gummy candies can incorporate most popular functional materials, making them quickly become a key food carrier for health and nutritional functionality.

Conventionally, gummy candies are produced in batches mainly in the following manufacturing process: weighing-mixing-cooking-deaeration-pouring/molding-drying-oil/sugar coating-post-processing-packaging.

Conventional slurry preparation processes involve the use of multiple tanks, including a sugar-dissolving tank, a gelatin-melting tank, a slurry-cooking tank, tanks for blending various functional materials, and a final mixing tank. Due to the high viscosity of the slurry system, it is difficult to achieve uniform dispersion of the functional materials. As a result, the batch size (tank volume) per production run is relatively small, typically ≤200 kg of slurry per batch. Therefore, scaling up production requires multiple parallel systems operating simultaneously. Generally, these conventional slurry preparation processes require numerous tanks, a long production time, and a lot of workers.

Air bubbles present in the slurry can interfere with the appearance and weight of the final candy product during the pouring process. Typical treatment methods involve maintaining the slurry at a controlled temperature while stirring and applying a vacuum to promote continuous flipping of the slurry, thereby accelerating the escape and removal of internal air bubbles. However, these methods have significant limitations, such as prolonging heating and holding time, affecting the stability of functional materials, and altering the composition of volatile components (for example, flavors and fragrances) in the slurry.

Conventional drying methods for gummy candies involve batch processing in drying chambers, where hot air drying is conducted at a temperature ≤45° C. and humidity <30%. Typically, the drying process takes over 48 h, making it time-consuming, energy-intensive, and space-inefficient. Additionally, drying positions need to be manually adjusted to ensure uniform moisture distribution across the product, which is a bottleneck in the entire process.

To sum up, existing gummy candy production processes in the prior art rely on step-by-step batch processing, requiring numerous pieces of equipment and involving complex and discontinuous operations. In addition, the preparation process demands multiple workers to operate sequentially, resulting in high labor intensity, prolonged production time, significant process losses, high production costs, and overall high energy consumption.

### SUMMARY

To overcome the shortcomings in the prior art, the present invention provides a gummy candy production system and method, where the system and method employ a continuous production process, featuring fewer and more streamlined pieces of equipment at the same production scale. The entire production line occupies a smaller footprint, consumes less energy, and reduces production costs while improving labor efficiency, demonstrating unique advantages in producing gelatin-based gummy candies containing functional materials.

The objectives of the present invention are achieved by the following technical solutions:
a gummy candy production system, including:
a slurry preparation system for dispersing, dissolving, and shear-mixing continuously supplied materials for preparing a gummy slurry to form a homogeneous gummy slurry, and continuously discharging the gummy slurry at a preset rate;
a continuous deaeration system for receiving and continuously deaerating the gummy slurry continuously discharged from the slurry preparation system, and discharging deaerated gummy slurry at a preset rate and temperature;
a flat sheet pouring system for receiving the gummy slurry continuously discharged from the continuous deaeration system, and processing the gummy slurry into candy bodies in a fixed shape;
an automatic cutting system for receiving the candy bodies continuously supplied from the flat sheet pouring system, and cutting the candy bodies into candy pieces in a preset size;
a drying system for receiving the candy pieces continuously supplied from the automatic cutting system, and continuously drying and discharging the candy pieces at a preset rate;
an oil coating and packaging system for receiving the candy pieces continuously discharged from the drying system, coating the candy pieces with oil, and packaging oil-coated candy pieces; and
a control system for receiving a product production information instruction and an order quantity, automatically retrieving a product formula, quantities of raw/auxiliary materials, and a production rate, and autonomously retrieving production process parameters of the slurry preparation system, the continuous deaeration system, the flat sheet pouring system, the automatic cutting system, the drying system, and the oil coating and packaging system.

Furthermore, the slurry preparation system includes a shear mixing apparatus, a plurality of feeding stations, a plurality of first heating devices, and a plurality of second heating devices, where the plurality of feeding stations are respectively used for storing materials with different properties and are all connected to the shear mixing apparatus for continuously conveying the materials with different properties to the shear mixing apparatus; the shear mixing apparatus is used for continuously dispersing, dissolving, and shear-mixing the materials to form the homogeneous gummy slurry; the control system is electrically connected to the feeding stations for controlling feed rates of the feeding stations and is electrically connected to the shear mixing apparatus for controlling shear rates of screws in the shear mixing apparatus; the plurality of first heating devices are all electrically connected to the control system and correspond one-to-one with the plurality of feeding stations to heat the feeding stations; and the plurality of second heating device are all electrically connected to the control system.

Furthermore, the continuous deaeration system includes a feed storage tank, a continuous deaerator, and a discharge storage tank, where the feed storage tank is used for temporarily storing the gummy slurry discharged from the slurry preparation system; the continuous deaerator is used for receiving and continuously deaerating the gummy slurry supplied from the feed storage tank; the discharge storage tank is used for receiving the slurry discharged from the continuous deaerator; and the control system is electrically connected to the continuous deaerator for synchronizing a rate at which the continuous deaerator discharges the slurry with that at which the slurry preparation system discharges the gummy slurry.

Furthermore, the feed storage tank is provided with a pair of first liquid level sensors and a first temperature control device, where the pair of first liquid level sensors are respectively arranged at high and low level positions in the feed storage tank; and both the first liquid level sensors and the first temperature control device are electrically connected to the control system;
when a slurry level in the feed storage tank is higher than a level of the first liquid level sensor at the high level position, the control system controls the continuous deaerator to operate continuously at a preset rate; and
when the slurry level in the feed storage tank is lower than a level of the first liquid level sensor at the low level position, the control system controls the continuous deaerator to stop operation.

Furthermore, the discharge storage tank is provided with a pair of second liquid level sensors and a second temperature control device, where the pair of second liquid level sensors are respectively arranged at high and low level positions in the discharge storage tank; and both the second liquid level sensors and the second temperature control device are electrically connected to the control system.

Furthermore, the flat sheet pouring system includes a transfer pump, an injection device, and flat sheet molds, where the transfer pump is electrically connected to the control system for transferring the slurry from the discharge storage tank to a material storage tank of the injection device; the control system is electrically connected to an inner push rod of the injection device; and the inner push rod is used for pushing the slurry from the material storage tank into mold cavities of the flat sheet molds;
when a slurry level in the discharge storage tank is higher than a level of the second liquid level sensor at the high level position, the transfer pump is started and operates at a preset transfer speed; and
when the slurry level in the discharge storage tank is lower than a level of the second liquid level sensor at the low level position, the transfer pump stops operation.

Furthermore, the material storage tank is provided with a pair of third liquid level sensors, where the pair of third liquid level sensors are respectively arranged at high and low level positions in the material storage tank; and the third liquid level sensors are electrically connected to the control system;
when a slurry level in the material storage tank is higher than a level of the third liquid level sensor at the high level position, the transfer pump stops operation; and
when the slurry level in the material storage tank is lower than a level of the third liquid level sensor at the low level position, the transfer pump is started and operates at a preset transfer speed.

Furthermore, the flat sheet pouring system further includes a frame, a conveying assembly, and a cooling device, where the conveying assembly includes a conveyor chain arranged on the frame and a motor for driving the conveyor chain; the flat sheet molds are uniformly distributed on the conveyor chain; the injection device is arranged at one end of the conveyor chain, while the cooling device is arranged at the other end of the conveyor chain for freezing the slurry in the flat sheet molds; and the control system is electrically connected to the motor for controlling a running speed of the conveyor chain and is electrically connected to the cooling device for controlling a cooling temperature of the cooling device.

Furthermore, the drying system includes an automatic feeding device, a discharge distributor, a belt conveyor, and a vacuum microwave device, where the automatic feeding device is electrically connected to the control system for feeding the candy pieces to a feed port of the vacuum microwave device; the discharge distributor is electrically connected to the control system for uniformly distributing the candy pieces from the feed port onto the belt conveyor; and the belt conveyor is electrically connected to the control system for conveying the candy pieces into the vacuum microwave device; the vacuum microwave device has a vacuum cavity formed therein, and the vacuum cavity is provided with a multi-layer conveying device therein for conveying the candy pieces and a microwave apparatus for providing different microwave heating powers for different layers; and both the conveying device and the microwave apparatus are electrically connected to the control system.

Furthermore, a first moisture detection sensor is arranged at the feed port of the vacuum microwave device; a second moisture detection sensor is arranged at a discharge port of the vacuum microwave device; and both the first moisture detection sensor and the second moisture detection sensor are electrically connected to the control system.

Furthermore, the oil coating and packaging system includes an oil coating machine, a packaging machine, and an inspection light, where the oil coating machine is electrically connected to the control system for coating dried candy pieces with oil; the inspection light is electrically connected to the control system for performing light inspection on oil-coated candy pieces; and the packaging machine is electrically connected to the control system for packaging light-inspected candy pieces.

A gummy candy production method, including the following steps:
inputting an instruction: inputting a product production information instruction and an order quantity into a control system, where the control system automatically retrieves a product formula, quantities of raw/auxiliary materials, a production rate, and production process parameters of each system, and after verification and confirmation, transmits the same to subsequent steps;
operating a slurry preparation system: dispersing, dissolving, and shear-mixing continuously supplied materials for preparing a gummy slurry to form a homogeneous gummy slurry, and continuously discharging the gummy slurry at a preset rate;
operating a continuous deaeration system: receiving and continuously deaerating the gummy slurry continuously discharged from the slurry preparation system, and discharging deaerated gummy slurry at a preset rate and temperature;
operating a flat sheet pouring system: receiving the gummy slurry continuously discharged from the continuous deaeration system, and processing the gummy slurry into candy bodies in a fixed shape;
operating an automatic cutting system: receiving the candy bodies continuously supplied from the flat sheet pouring system, and cutting the candy bodies into candy pieces in a preset size;
operating a drying system: receiving the candy pieces continuously supplied from the automatic cutting system, and continuously drying and discharging the candy pieces at a preset rate; and
operating an oil coating and packaging system: receiving the candy pieces continuously discharged from the drying system, coating the candy pieces with oil, and packaging oil-coated candy pieces.

Furthermore, the step of operating the slurry preparation system specifically includes the following steps:
weighing corresponding weight portions of materials according to the formula and classifying the materials according to their properties, adding the materials into feeding stations, and performing temperature control on the materials through first heating devices respectively according to their properties;
calculating and setting, by the system, feed rates of the materials into a shear mixing apparatus according to mass proportions of the materials in total materials;
preheating the shear mixing apparatus through second heating devices; and
opening the feeding stations, and dispersing, dissolving, and shear-mixing, by the shear mixing apparatus, the materials continuously supplied from the feeding stations to form the homogeneous gummy slurry, and continuously discharging the gummy slurry at a preset rate.

Furthermore, the step of operating the continuous deaeration system specifically includes the following steps:
feeding the gummy slurry continuously produced by the slurry preparation system into a feed storage tank according to a preset yield; automatically starting a continuous deaerator to operate at a preset deaeration rate and corresponding process parameters when first liquid level sensors in the feed storage tank detect the gummy slurry; and transferring deaerated gummy slurry to a discharge storage tank.

Furthermore, the step of operating the drying system specifically includes the following steps:
feeding, by an automatic feeding device, the candy pieces to a feed port of a vacuum microwave device; uniformly distributing, by a discharge distributor, the candy pieces from the feed port onto a belt conveyor; conveying, by the belt conveyor, the candy pieces into the vacuum microwave device; conveying, by a conveying device in the vacuum microwave device, the candy pieces downward layer by layer; and drying, by a microwave apparatus, the candy pieces when they are conveyed downward layer by layer.

Compared with the prior art, the present invention has the following advantages:
1. the fully automated gummy candy production system integrates the control system, the slurry preparation system, the continuous deaeration system, the flat sheet pouring system, the automatic cutting system, the drying system, and the oil coating and packaging system to achieve full automation and intelligent production of gummy candies; the production process is simplified and highly continuous, significantly improving production efficiency and drastically reducing production time which is controlled within 8-10 h from feeding the materials to obtaining the final gummy candy products; in addition, the gummy candy production system can operate continuously, and the optimized overall process and equipment reduce factory space requirements and enhance economic benefits;
2. parameter settings in the control system enable easy product changeover and adjustment in the gummy candy production system;
3. when the fully automated gummy candy production system operates integrally, except for those required for material preparation, only 1-2 operators are required to monitor system operation and equipment status, reducing operator workload and achieving labor savings across the entire production line;
4. the integration of the continuous deaerator into the entire production process enables a fully continuous production process, thereby reducing equipment requirements, energy consumption, and product processing time, which achieves both improved gummy candy appearance and continuous production efficiency, and demonstrates unique advantages in producing high-viscosity gelatin-based gummy candies and heat-sensitive functional materials;
5. the vacuum microwave device combines the vacuum cavity and the microwave apparatus therein to accelerate internal moisture migration in the gummy candies, significantly improving drying efficiency and requiring only 4-6 h for the whole drying process. Since the drying operation is carried out in a vacuum environment at a relatively low temperature, it can meet the processing requirements of most heat-sensitive materials. By using a continuous vacuum dryer, it overcomes the technical difficulty of continuously feeding and discharging materials under a vacuum state, and successfully transforms static drying into dynamic drying. The automated programmed control system maintains a good appearance of the gummy candies, greatly improves drying efficiency, and fully reduces the overall production cost; and
6. compared with conventional technologies, the system and method employ a continuous production process, featuring fewer and more streamlined pieces of equipment at the same production scale. The entire production line occupies a smaller footprint, consumes less energy, and reduces production costs while improving labor efficiency, demonstrating unique advantages in producing gelatin-based gummy candies containing functional materials.

### BRIEF DESCRIPTION OF THE DRAWINGS

FIG. 1 is a schematic block diagram of a gummy candy production system according to an embodiment of the present invention;

FIG. 2 is a schematic block diagram of a slurry preparation system;

FIG. 3 is a schematic block diagram of a continuous deaeration system;

FIG. 4 is a schematic block diagram of a flat sheet pouring system;

FIG. 5 is a schematic block diagram of a drying system;

FIG. 6 is a schematic block diagram of an oil coating and packaging system; and

FIG. 7 is a flow chart of a gummy candy production method according to an embodiment of the present invention.

Reference signs used in the figures: 1. slurry preparation system; 10. shear mixing apparatus; 11. feeding station; 12. first heating device; 13. second heating device; 2. continuous deaeration system; 20. feed storage tank; 200. first liquid level sensor; 201. first temperature control device; 21. continuous deaerator; 22. discharge storage tank; 220. second liquid level sensor; 221. second temperature control device; 3. flat sheet pouring system; 30. transfer pump; 31. injection device; 310. material storage tank; 311. inner push rod; 32. flat sheet mold; 320. mold cavity; 33. third liquid level sensor; 34. frame; 35. conveying assembly; 350. conveyor chain; 351. Motor; 36. Cooling device; 4. automatic cutting system; 5. drying system; 50. automatic feeding device; 51. belt conveyor; 52. vacuum microwave device; 520. vacuum cavity; 521. conveying device; 522. microwave apparatus; 53. first moisture detection sensor; 54. second moisture detection sensor; 55. discharge distributor; 6. oil coating and packaging system; 60. oil coating machine; 61. packaging machine; 62. inspection light; and 7. control system.

### DETAILED DESCRIPTION OF THE EMBODIMENTS

The technical solutions of the present invention are further described in detail below with reference to preferred embodiments and their accompanying drawings, but the description is not intended to constitute any limitation. In the description of the present invention, it should be understood that the orientations or positional relationships indicated by the terms “center”, “longitudinal”, “transverse”, “length”, “width”, “thickness”, “up”, “down”, “front”, “back”, “left”, “right”, “vertical”, “horizontal”, “top”, “bottom”, “inside”, “outside”, “clockwise”, “counter-clockwise”, “axial”, “radial”, “circumferential”, and the like are based on those shown in the accompanying drawings. Furthermore, the terms “first” and “second” are intended only for descriptive purposes and should not be construed as indicating or implying their relative importance or implicitly indicating the quantity of technical features indicated. Therefore, defining a feature with “first” and “second” can explicitly or implicitly indicate that at least one of such features is included. In the description of the present invention, “a plurality of” refers to at least two, for example, two or three, unless otherwise specifically defined. The embodiments described below with reference to the accompanying drawings are exemplary and are intended to explain the present invention, but shall not be understood as a limitation on the present invention.

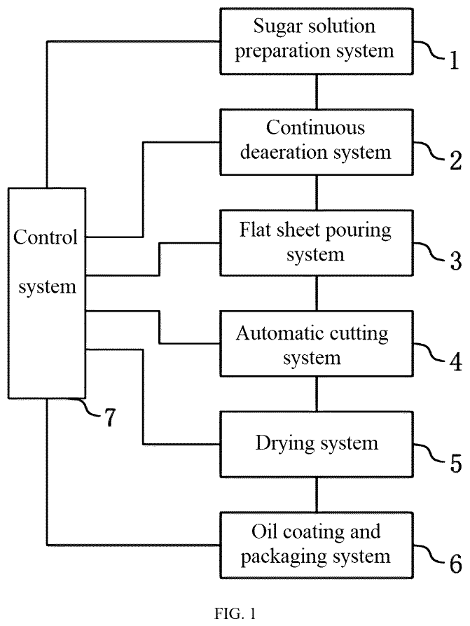

As shown in FIG. 1, an embodiment of the present invention provides a gummy candy production system, including a slurry preparation system 1, a continuous deaeration system 2, a flat sheet pouring system 3, an automatic cutting system 4, a drying system 5, an oil coating and packaging system 6, and a control system 7, where the slurry preparation system 1 is used for dispersing, dissolving, and shear-mixing continuously supplied materials for preparing a gummy slurry to form a homogeneous gummy slurry, and continuously discharging the gummy slurry at a preset rate; the continuous deaeration system 2 is used for receiving and continuously deaerating the gummy slurry continuously discharged from the slurry preparation system 1, and discharging deaerated gummy slurry at a preset rate and temperature; the flat sheet pouring system 3 is used for receiving the gummy slurry continuously discharged from the continuous deaeration system 2, and processing the gummy slurry into candy bodies in a fixed shape; the automatic cutting system 4 is used for receiving the candy bodies continuously supplied from the flat sheet pouring system 3, and cutting the candy bodies into candy pieces in a preset size; the drying system 5 is used for receiving the candy pieces continuously supplied from the automatic cutting system 4, and continuously drying and discharging the candy pieces at a preset rate; the oil coating and packaging system 6 is used for receiving the candy pieces continuously discharged from the drying system 5, coating the candy pieces with oil, and packaging oil-coated candy pieces; and the control system 7 is used for receiving a product production information instruction and an order quantity, automatically retrieving a product formula, quantities of raw/auxiliary materials, and a production rate, and autonomously retrieving production process parameters of the slurry preparation system 1, the continuous deaeration system 2, the flat sheet pouring system 3, the automatic cutting system 4, the drying system 5, and the oil coating and packaging system 6.

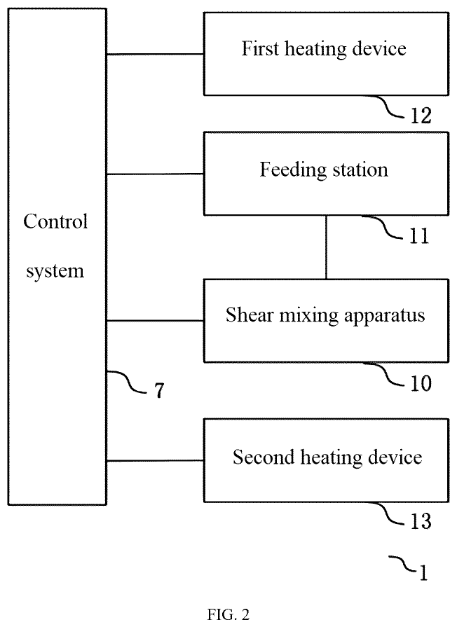

As shown in FIG. 2, the slurry preparation system 1 includes a shear mixing apparatus 10, a plurality of feeding stations 11, a plurality of first heating devices 12, and a plurality of second heating devices 13, where the plurality of feeding stations 11 are respectively used for storing materials with different properties and are all connected to the shear mixing apparatus 10 for continuously conveying the materials with different properties to the shear mixing apparatus 10; the shear mixing apparatus 10 is used for continuously dispersing, dissolving, and shear-mixing the materials to form the homogeneous gummy slurry; the control system 7 is electrically connected to the feeding stations 11 for controlling feed rates of the feeding stations 11 and is electrically connected to the shear mixing apparatus 10 for controlling shear rates of screws in the shear mixing apparatus 10; the plurality of first heating devices 12 are all electrically connected to the control system 7 and correspond one-to-one with the plurality of feeding stations 11 to heat the feeding stations 11; and the plurality of second heating device 13 are all electrically connected to the control system 7.

Specifically, the feeding stations 11 and the shear mixing apparatus 10 are connected through pipelines, and regulating valves are arranged on the pipelines to control flow rates of the materials in the feeding stations 11 flowing into the shear mixing apparatus 10, where the regulating valves can be controlled by the control system 7.

After the materials enter the shear mixing apparatus 10, the control system 7 controls a motor to drive double screws to rotate. The double screws disperse, dissolve, and shear-mix the materials in the shear mixing apparatus 10 to form the homogeneous gummy slurry, and simultaneously discharge the gummy slurry to a discharge port of the shear mixing apparatus 10.

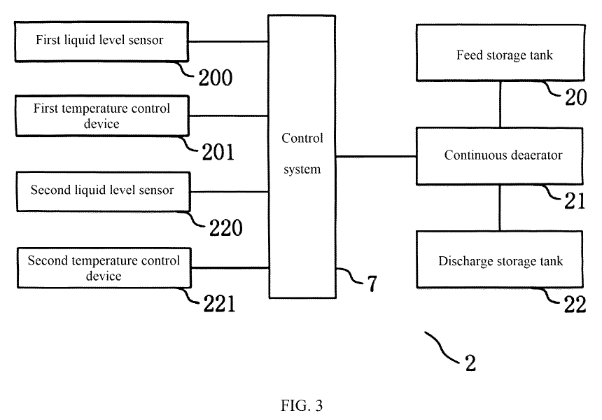

As shown in FIG. 3, the continuous deaeration system 2 includes a feed storage tank 20, a continuous deaerator 21, and a discharge storage tank 22, where the feed storage tank 20 is used for temporarily storing the gummy slurry discharged from the slurry preparation system 1; the continuous deaerator 21 is used for receiving and continuously deaerating the gummy slurry supplied from the feed storage tank 20; the discharge storage tank 22 is used for receiving the slurry discharged from the continuous deaerator 21; and the control system 7 is electrically connected to the continuous deaerator 21 for synchronizing a rate at which the continuous deaerator 21 discharges the slurry with that at which the slurry preparation system 1 discharges the gummy slurry.

The feed storage tank 20 is provided with a pair of first liquid level sensors 200 and a first temperature control device 201, where the pair of first liquid level sensors 200 are respectively arranged at high and low level positions in the feed storage tank 20; and both the first liquid level sensors 200 and the first temperature control device 201 are electrically connected to the control system 7; when a slurry level in the feed storage tank 20 is higher than a level of the first liquid level sensor 200 at the high level position, the control system 7 controls the continuous deaerator 21 to operate continuously at a preset rate; and when the slurry level in the feed storage tank 20 is lower than a level of the first liquid level sensor 200 at the low level position, the control system 7 controls the continuous deaerator 21 to stop operation, thereby preventing dry running of the continuous deaerator 21. The first temperature control device 201 ensures a stable temperature of the feed storage tank 20 so that the temperature remains within a product processing temperature range.

The discharge storage tank 22 is provided with a pair of second liquid level sensors 220 and a second temperature control device 221, where the pair of second liquid level sensors 220 are respectively arranged at high and low level positions in the discharge storage tank 22; and both the second liquid level sensors 220 and the second temperature control device 221 are electrically connected to the control system 7. The second temperature control device 221 ensures a stable temperature of the discharge storage tank 22 so that the temperature remains within the product processing temperature range.

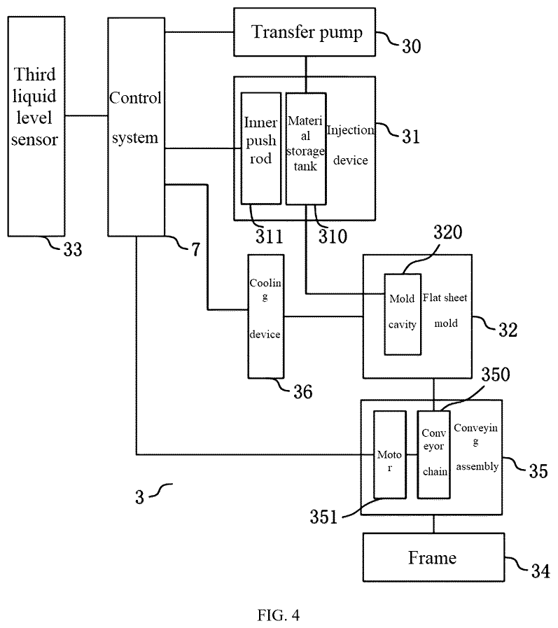

As shown in FIG. 4, the flat sheet pouring system 3 includes a transfer pump 30, an injection device 31, and flat sheet molds 32, where the transfer pump 30 has a suction port connected to the discharge storage tank 22 and a discharge port arranged in a material storage tank 310 of the injection device 31; the transfer pump 30 is electrically connected to the control system 7 for transferring the slurry from the discharge storage tank 22 to the material storage tank 310 of the injection device 31; the control system 7 is electrically connected to an inner push rod 311 of the injection device 31; and the inner push rod 311 is used for pushing the slurry from the material storage tank 310 into mold cavities 320 of the flat sheet molds 32, where at least one mold cavity 320 is arranged on a top surface of each of the flat sheet molds 32. In this embodiment, the flat sheet molds 32 are common flat sheets or flat sheet trays with grooves of different shapes.

When a slurry level in the discharge storage tank 22 is higher than a level of the second liquid level sensor 220 at the high level position, the transfer pump 30 is started and operates at a preset transfer rate; and when the slurry level in the discharge storage tank 22 is lower than a level of the second liquid level sensor 220 at the low level position, the transfer pump 30 stops operation.

The material storage tank 310 is provided with a pair of third liquid level sensors 33, where the pair of third liquid level sensors 33 are respectively arranged at high and low level positions in the material storage tank 310; and the third liquid level sensors 33 are electrically connected to the control system 7; when a slurry level in the material storage tank 310 is higher than a level of the third liquid level sensor 33 at the high level position, the transfer pump 30 stops operation; and when the slurry level in the material storage tank 310 is lower than a level of the third liquid level sensor 33 at the low level position, the transfer pump 30 is started and operates at a preset transfer speed, thereby ensuring a sufficient quantity of material in the material storage tank 310 and facilitating continuous pouring by the flat sheet pouring system 3.

The flat sheet pouring system 3 further includes a frame 34, a conveying assembly 35, and a cooling device 36, where the conveying assembly 35 includes a conveyor chain 350 arranged on the frame 34 and a motor 351 for driving the conveyor chain 350; the flat sheet molds 32 are all arranged on the conveyor chain 350 in sequence along a conveying direction of the conveyor chain 350; the injection device 31 is arranged both on the frame 34 and at one end of the conveyor chain 350, while the cooling device 36 is arranged both on the frame 34 and at the other end of the conveyor chain 350 for freezing the slurry in the flat sheet molds 32; and the control system 7 is electrically connected to the motor 351 for controlling a running speed of the conveyor chain 350 and is electrically connected to the cooling device 36 for controlling a cooling temperature of the cooling device 36.

After the pouring process starts, the material storage tank 310 will automatically feed and control the slurry amount in the mold cavity 320; at this time, the inner push rod 311 of the injection device 31 pushes the slurry through an injection port into one flat sheet mold 32; once the injection is completed, the injection port is closed; when the next flat sheet mold 32 is in position, the injection operation repeats, and the injected flat sheet mold 32 is then conveyed by the conveyor chain 350 to the cooling device 36; and after cooling, the mold is inverted for release, the released candy body is conveyed by a receiving belt to the next process, and the emptied flat sheet mold 32 returns to the injection position along the circular conveyor chain 350. This cycle repeats in turn. The control system 7 controls the rate control parameters of the transfer pump 30, the parameter setting and automatic control of each process point of the injection device 31, the conveying speed of the flat sheet molds 32, and the process parameters of the cooling device 36.

The automatic cutting system 4 mainly cuts the cooled large candy bodies into candy pieces of the required size. The released candy bodies are conveyed by the belt to a position below an automatic cutting device, where the cutting device performs horizontal and vertical cutting on the entire candy bodies according to preset cut length and width, and then, the cut candy pieces are conveyed by the belt to the next drying step.

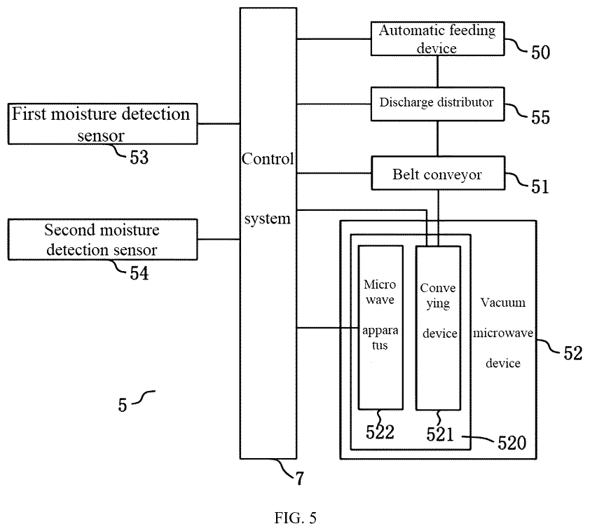

As shown in FIG. 5, the drying system 5 includes an automatic feeding device 50, a discharge distributor 55, a belt conveyor 51, and a vacuum microwave device 52, where the automatic feeding device 50 is electrically connected to the control system 7 for feeding the candy pieces to a feed port of the vacuum microwave device 52; the discharge distributor 55 is electrically connected to the control system 7 for uniformly distributing the candy pieces from the feed port onto the belt conveyor 51; and the belt conveyor 51 is electrically connected to the control system 7 for conveying the candy pieces into the vacuum microwave device 52; the vacuum microwave device 52 has a vacuum cavity 520 formed therein, and the vacuum cavity 520 is provided with a multi-layer conveying device 521 therein for conveying the candy pieces and a microwave apparatus 522 for providing different microwave heating powers for different layers; and both the conveying device 521 and the microwave apparatus 522 are electrically connected to the control system 7.

A first moisture detection sensor 53 is arranged at the feed port of the vacuum microwave device 52; a second moisture detection sensor 54 is arranged at a discharge port of the vacuum microwave device 52; and both the first moisture detection sensor 53 and the second moisture detection sensor 54 are electrically connected to the control system 7.

The cut candy pieces are conveyed by the belt to the automatic feeding device 50, which lifts the candy pieces to the feed port of the vacuum microwave device 52. The candy pieces at the feed port are then distributed by the discharge distributor 55 onto the belt of the belt conveyor 51. The multi-layer conveying device 521 of the drying system 5 is entirely housed within the enclosed vacuum cavity 520. The vacuum cavity 520 can maintain different vacuum degrees, while the microwave apparatus 522 installed inside the vacuum cavity 520 provides different microwave heating powers for different layers. The candy pieces on the conveying device 521 are conveyed downward layer by layer, and finally reach the discharge port. The entire conveying process is the drying process, and the control system 7 sets the product and feed moisture to provide corresponding vacuum microwave and other process parameters for each section.

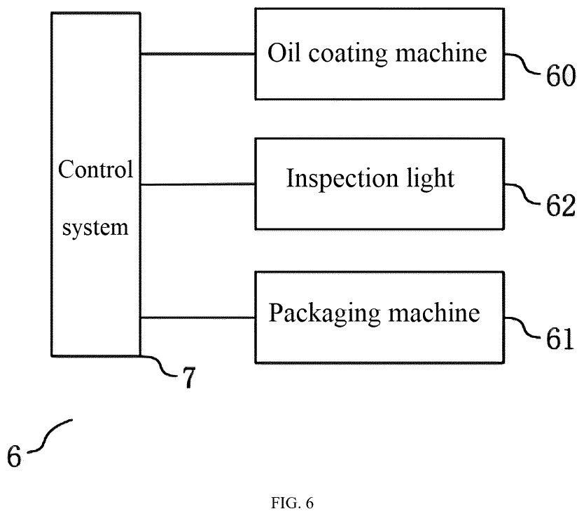

As shown in FIG. 6, the oil coating and packaging system 6 includes an oil coating machine 60, a packaging machine 61, and an inspection light 62, where the oil coating machine 60 is electrically connected to the control system 7 for coating dried candy pieces with oil; the inspection light 62 is electrically connected to the control system 7 for performing light inspection on oil-coated candy pieces; and the packaging machine 61 is electrically connected to the control system 7 for packaging light-inspected candy pieces.

The dried candy pieces are discharged and conveyed by the belt to the oil coating and packaging system 6. After oil coating, the candy pieces are continuously discharged and, after being subjected to light inspection, are packaged by the subsequent packaging machine 61.

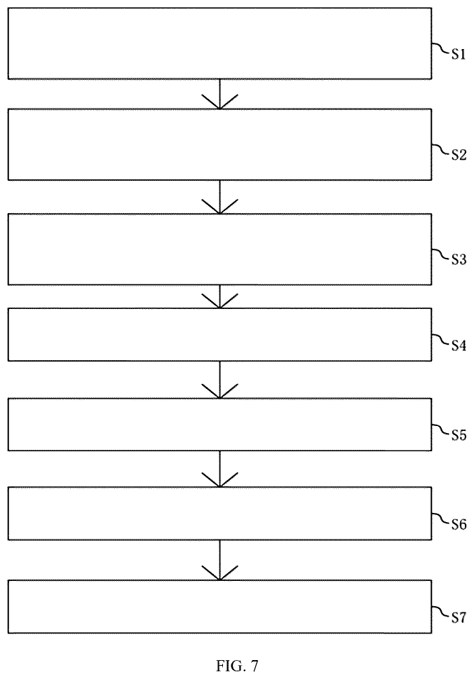

As shown in FIG. 7, an embodiment of the present invention provides a gummy candy production method, including the following steps:

S1: inputting an instruction: inputting a product production information instruction and an order quantity into a control system 7, where the control system 7 automatically retrieves a product formula, quantities of raw/auxiliary materials, a production rate, and production process parameters of each system, and after verification and confirmation, transmits the same to subsequent steps.

S2: operating a slurry preparation system 1: dispersing, dissolving, and shear-mixing continuously supplied materials for preparing a gummy slurry to form a homogeneous gummy slurry, and continuously discharging the gummy slurry at a preset rate.

The step S2 specifically includes the following steps:
S20: weighing corresponding weight portions of materials according to the formula and classifying the materials according to their properties, adding the materials into feeding stations 11, and performing temperature control on the materials through first heating devices 12 respectively according to their properties;
S21: calculating and setting, by the system, feed rates of the materials into a shear mixing apparatus 10 according to mass proportions of the materials in total materials;
S22: preheating the shear mixing apparatus 10 through the second heating devices 13; and
S23: opening the feeding stations 11, and dispersing, dissolving, and shear-mixing, by the shear mixing apparatus 10, the materials continuously supplied from the feeding stations 11 to form the homogeneous gummy slurry, and continuously discharging the gummy slurry at a preset rate.

S3: operating a continuous deaeration system 2: receiving and continuously deaerating the gummy slurry continuously discharged from the slurry preparation system 1, and discharging deaerated gummy slurry at a preset rate and temperature.

Specifically, the gummy slurry continuously produced by the slurry preparation system 1 is fed into a feed storage tank 20 according to a preset yield; when first liquid level sensors 200 in the feed storage tank 20 detect the gummy slurry, a continuous deaerator 21 is automatically started to operate at a preset deaeration rate and corresponding process parameters; and deaerated gummy slurry is transferred to a discharge storage tank 22.

When a slurry level in the feed storage tank 20 is lower than a level of the first liquid level sensor 200 at a low level position, the control system 7 controls the continuous deaerator 21 to stop operation, thereby preventing dry running of the continuous deaerator 21.

The discharge storage tank 22 is provided with second liquid level sensors 220. When a slurry level in the discharge storage tank 22 is higher than a level of the second liquid level sensor 220 at a high level position, a transfer pump 30 is started and operates at a preset transfer speed to transfer the slurry in the discharge storage tank 22 to a flat sheet pouring system 3; and when the slurry level in the discharge storage tank 22 is lower than a level of the second liquid level sensor 220 at a low level position, the transfer pump 30 stops operation.

A first temperature control device 201 ensures a stable temperature of the feed storage tank 20 so that the temperature remains within a product processing temperature range. A second temperature control device 221 ensures a stable temperature of the discharge storage tank 22 so that the temperature remains within the product processing temperature range. The first temperature control device 201 also ensures a stable temperature in a connecting pipeline between the feed storage tank 20 and the continuous deaerator 21, while the second temperature control device 221 also ensures a stable temperature in a connecting pipeline between the discharge storage tank 22 and the continuous deaerator 21. Therefore, it is ensured that the slurry temperature remains within the product processing temperature range.

S4: operating a flat sheet pouring system 3: receiving the gummy slurry continuously discharged from the continuous deaeration system 2, and processing the gummy slurry into candy bodies in a fixed shape.

Specifically, the control system 7 automatically sets the speed control parameters of the transfer pump 30, the parameter setting and automatic control of each process point of an injection device 31, the conveying speed of flat sheet molds 32, and the process parameters of a cooling device 36. The transfer pump 30 transfers the slurry to a material storage tank 310 of the injection device 31; when a third liquid level sensor 33 in the material storage tank 310 detects the slurry reaching a high level, it triggers activation of the flat sheet pouring system 3; at this time, an inner push rod 311 of the injection device 31 pushes the slurry through an injection port into one flat sheet mold 32; once the injection is completed, the injection port is closed; when the next flat sheet mold 32 is in position, the injection operation repeats, and the injected flat sheet mold 32 is then conveyed by a conveyor chain 350 to the cooling device 36; and after cooling, the mold is inverted for release, the released candy body is conveyed by a receiving belt to the next process, and the emptied flat sheet mold returns to the injection position along the circular conveyor chain 350. This cycle repeats in turn.

S5: operating an automatic cutting system 4: receiving the candy bodies continuously supplied from the flat sheet pouring system 3, and cutting the candy bodies into candy pieces in a preset size.

Specifically, the released candy bodies are conveyed by the belt to a position below the automatic cutting system 4, where the automatic cutting system 4 performs horizontal and vertical cutting on the entire candy bodies according to preset cut length and width, and then, the cut candy pieces are conveyed by the belt to the next drying step.

S6: operating a drying system 5: receiving the candy pieces continuously supplied from the automatic cutting system 4, and continuously drying and discharging the candy pieces at a preset rate.

Specifically, the candy pieces are fed by an automatic feeding device 50 to a feed port of a vacuum microwave device 52; then, the candy pieces are uniformly distributed by a discharge distributor 55 from the feed port onto a belt conveyor 51; next, the candy pieces are conveyed by the belt conveyor 51 into the vacuum microwave device 52; further, the candy pieces are conveyed downward layer by layer by a conveying device 521 in the vacuum microwave device 52; and when the candy pieces are conveyed downward layer by layer, they are dried by a microwave apparatus 522.

Specifically, the cut candy pieces are conveyed by the belt to the automatic feeding device 50 including two buffer tanks, where the candy pieces are lifted by the belt and alternately distributed into the two buffer tanks through a switching device. The switching operation is performed once every few minutes. When one buffer tank is fully loaded, its upper valve is closed while its lower valve is opened, allowing the candy pieces to drop into the feed inlet of the vacuum microwave device 52. Then, the discharge distributor 55 distributes the candy pieces on the belt of the belt conveyor 51. Once the buffer tank is emptied, upon reaching the switching time, the lower valve is closed while the upper valve is reopened to receive new candy pieces. The two buffer tanks alternately feed the drying system 5 in sequence to ensure the vacuum degree of the system. A first moisture detection sensor 53 detects an initial moisture content of incoming candy pieces, and corresponding process parameters, such as vacuum microwave settings of each section, are automatically selected based on the detected moisture content. The candy pieces on the conveying device 521 are conveyed downward layer by layer and dried, and finally reach the discharge port. A second moisture detection sensor 54 at a rear section of the discharge port detects a moisture content of the candy pieces at the discharge port.

S7: operating an oil coating and packaging system 6: receiving the candy pieces continuously discharged from the drying system 5, coating the candy pieces with oil, and packaging oil-coated candy pieces.

Specifically, the dried candy pieces are discharged and conveyed by the belt to an oil coating machine 60 of the oil coating and packaging system 6. After oil coating, the candy pieces are continuously discharged and, after being subjected to light inspection by an inspection light 62, are packaged by a subsequent packaging machine 61.

In order to further understand the technical solutions of the present invention, an embodiment will be provided below as an aid for technical understanding.

This embodiment employs the above-described gummy candy production system to produce a “multivitamin pectin-based gummy candy” (code: MV2P). The production process includes the following steps:

S1: inputting a production information instruction “MV2P” and an order quantity (1,000 kg) into the control system 7, which automatically retrieves a formula of the product, quantities of raw/auxiliary materials, a production rate, and production process parameters of each step, and after verification and confirmation, transmits the same to the control devices of subsequent steps.

The step S1 specifically includes the following steps:

S10: inputting a production information instruction “MV2P” and an order quantity (1,000 kg) into the control system 7.

S11: automatically retrieving, by the control system 7, a formula of the product and quantities of raw/auxiliary materials. The total materials required for the formulation of MV2P are classified into solid-phase materials, aqueous-phase materials, aqueous-phase functional materials, oil-phase functional materials, and other ingredients according to their properties, and the quantities of raw/auxiliary materials required for the order are calculated. The specific classification and quantities are shown in Table 1 below.

TABLE 1
Classification of Total Materials Required for MV2P

| | Proportion | | Proportion | Quantity |
|---|---|---|---|---|
| | in Total | | in Total | for the |
| Mixture | Materials | | Materials | Order |
| Name | (%) | Material Name | (%) | (kg) |
| Solid-phase | 36.486 | White granulated | 34.171 | 341.71 |
| materials | | sugar | | |
| | | Pectin | 2.315 | 23.15 |
| Aqueous- | 54.283 | Glucose syrup | 35.935 | 359.35 |
| phase | | Purified water | 18.018 | 180.18 |
| materials | | Sodium citrate | 0.330 | 3.3 |
| Oil-phase | 0.417 | Vitamin E oil | 0.402 | 4.02 |
| functional | | Vitamin A acetate oil | 0.015 | 0.15 |
| materials | | | | |
| Aqueous- | 6.831 | Vitamin C | 0.556 | 5.56 |
| phase | | Vitamin D3 (powder) | 0.056 | 0.56 |
| materials | | Calcium pantothenate | 0.590 | 5.9 |
| | | Biotin | 0.076 | 0.76 |
| | | Sodium citrate | 0.167 | 1.67 |
| | | Glucose syrup | 4.274 | 42.74 |
| | | Purified water | 1.112 | 11.12 |
| Other | 1.983 | DL-Malic acid | 0.526 | 5.26 |
| ingredients | | Anhydrous citric acid | 0.240 | 2.4 |
| | | Purified water | 0.767 | 7.67 |
| | | Peach essence | 0.397 | 3.97 |
| | | Black carrot juice | 0.053 | 0.53 |
| | | concentrate | | |
| Total: | 100 | | | 1000 |

This table is submitted to the batching workstation, where the materials are weighed and batched according to the formula listed in the table.

S12: automatically selling, by the control system 7, process parameters of the continuous slurry preparation system. According to the production capacity (200 kg/h) of the shear mixing apparatus 10, the feed rates of various materials in the total materials required for MV2P entering the shear mixing apparatus meet the conditions shown in Table 2 below.

TABLE 2
Feed Rates of Various Materials in
Total Materials Required for MV2P

| | Mass Proportion | | |
|---|---|---|---|
| | in Total | Feed rate | |
| Mixture Name | Materials (%) | (kg/h) | Condition |
| Solid-phase | 36.486 | 72.972 | Vₐ = 200 × 36.486% |
| materials | | | |
| Aqueous-phase | 54.283 | 108.566 | V_{b} = 200 × 54.283% |
| materials | | | |
| Aqueous-phase | 0.417 | 0.834 | V_{c} = 200 × 0.417% |
| functional | | | |
| materials | | | |
| Oil-phase | 6.831 | 13.662 | V_{d} = 200 × 6.831% |
| functional | | | |
| materials | | | |
| Other | 1.983 | 3.964 | Vₑ = 200 × 1.982% |
| ingredients | | | |

Temperature control for each feeding station: feeding station of aqueous-phase materials: 70~90° C.; feeding station of aqueous-phase functional materials: 40~60° C.; feeding station of oil-phase functional materials: 40~60° C.; and feeding station of other ingredients: 40~60° C.

System parameters set for the shear mixing apparatus 10: material processing rate: 200 kg/h; temperature control for each zone of the shear mixing apparatus: 90~120° C.

S13: automatically setting, by the control system 7, process parameters of other systems.

Continuous deaeration system 2: external holding temperature: 90-110° C.; vacuum degree: −80-90 kPa; material processing rate: 200 kg/h.

Flat sheet pouring system 3: pouring temperature: 90° C.; pouring rate: 200 kg/h; cooling tunnel: cold air temperature: 6-8° C., and air rate: 7-8 m/s; conveyor belt speed: 0.015 m/s.

Automatic cutting device 4: cutting candy pieces in different sizes as required by the customer, such as 15 mm×15 mm; material processing rate: 200 kg/h.

Drying system 5: temperature: 50-55° C.; vacuum degree: −0.1-−0.075 MPa; microwave power: 0.5-2 kW; time: 4-6 h; moisture detection result at the discharge port: about 16%.

Oil coating and packaging system 6: conveyor belt speed range: 70%-90%; set oil coating rate: 60%-90%; anti-sticking oil supply rate: F20-40; overall material processing rate: 200 kg/h. The oil-coated samples are packaged according to the order requirements.

S2: operating a slurry preparation system 1: dispersing, dissolving, and shear-mixing continuously supplied materials for preparing a gummy slurry to form a homogeneous gummy slurry, and continuously discharging the gummy slurry at a preset rate.

The step S2 specifically includes the following steps:
S20: weighing corresponding weight portions of materials according to the formula (as shown in Table 1) and classifying the materials according to their properties, adding the materials in Table 1 into feeding stations 11, and performing temperature control on the materials through first heating devices 12 respectively according to their properties;
S21: setting feed rates of the materials into the shear mixing apparatus 10 according to Table 2;
S22: preheating the shear mixing apparatus 10 through the second heating devices 13; and
S23: opening the feeding stations 11, and dispersing, dissolving, and shear-mixing, by the shear mixing apparatus 10, the materials continuously supplied from the feeding stations 11 to form the homogeneous gummy slurry, and continuously discharging the gummy slurry at a preset rate.

The step S23 specifically includes the following steps:
automatically discharging the slurry formed by inadequately mixed solid-phase materials, aqueous-phase materials, aqueous-phase functional materials, oil-phase functional materials, and other ingredients into a waste container during the first 2 minutes of operation of the shear mixing apparatus 10, and after this 2-minute period, automatically switching an outlet valve of the shear mixing apparatus 10 to direct the slurry to the feed storage tank 20 of the continuous deaeration system 2 to obtain a homogeneous MV2P slurry.

S3: operating a continuous deaeration system 2: receiving and continuously deaerating the gummy slurry continuously discharged from the slurry preparation system 1, and discharging deaerated gummy slurry at a preset rate and temperature.

Specifically, the gummy slurry continuously produced by the slurry preparation system 1 is fed into the feed storage tank 20 according to a preset yield; when the first liquid level sensors 200 in the feed storage tank 20 detect the gummy slurry, the continuous deaerator 21 is automatically started to operate at a preset deaeration rate and corresponding process parameters; and deaerated gummy slurry is transferred to the discharge storage tank 22.

When a slurry level in the feed storage tank 20 is lower than a level of the first liquid level sensor 200 at a low level position, the control system 7 controls the continuous deaerator 21 to stop operation, thereby preventing dry running of the continuous deaerator 21.

The discharge storage tank 22 is provided with the second liquid level sensors 220. When a slurry level in the discharge storage tank 22 is higher than a level of the second liquid level sensor 220 at the high level position, the transfer pump 30 is started and operates at a preset transfer speed to transfer the slurry in the discharge storage tank 22 to the flat sheet pouring system 3; and when the slurry level in the discharge storage tank 22 is lower than a level of the second liquid level sensor 220 at the low level position, the transfer pump 30 stops operation.

A first temperature control device 201 ensures a stable temperature of the feed storage tank 20 so that the temperature remains within a product processing temperature range. A second temperature control device 221 ensures a stable temperature of the discharge storage tank 22 so that the temperature remains within the product processing temperature range. The first temperature control device 201 also ensures a stable temperature in a connecting pipeline between the feed storage tank 20 and the continuous deaerator 21, while the second temperature control device 221 also ensures a stable temperature in a connecting pipeline between the discharge storage tank 22 and the continuous deaerator 21. Therefore, it is ensured that the slurry temperature remains within the product processing temperature range.

S4: operating a flat sheet pouring system 3: receiving the gummy slurry continuously discharged from the continuous deaeration system 2, and processing the gummy slurry into candy bodies in a fixed shape.

Specifically, the control system 7 automatically sets the speed control parameters of the transfer pump 30, the parameter setting and automatic control of each process point of an injection device 31, the conveying speed of flat sheet molds 32, and the process parameters of a cooling device 36. The transfer pump 30 transfers the slurry to the material storage tank 310 of the injection device 31; when the third liquid level sensor 33 in the material storage tank 310 detects the slurry reaching a high level, it triggers activation of the flat sheet pouring system 3; at this time, the inner push rod 311 of the injection device 31 pushes the slurry through an injection port into one flat sheet mold 32; once the injection is completed, the injection port is closed; when the next flat sheet mold 32 is in position, the injection operation repeats, and the injected flat sheet mold 32 is then conveyed by a conveyor chain 350 to the cooling device 36; and after cooling, the mold is inverted for release, the released candy body is conveyed by a receiving belt to the next process, and the emptied flat sheet mold returns to the injection position along the circular conveyor chain 350. This cycle repeats in turn.

S5: operating an automatic cutting system 4: receiving the candy bodies continuously supplied from the flat sheet pouring system 3, and cutting the candy bodies into candy pieces in a preset size.

Specifically, the released candy bodies are conveyed by the belt to a position below the automatic cutting system 4, where the automatic cutting system 4 performs horizontal and vertical cutting on the entire candy bodies according to preset cut length and width, and then, the cut candy pieces are conveyed by the belt to the next drying step.

S6: operating a drying system 5: receiving the candy pieces continuously supplied from the automatic cutting system 4, and continuously drying and discharging the candy pieces at a preset rate.

Specifically, the candy pieces are fed by an automatic feeding device 50 to a feed port of a vacuum microwave device 52; then, the candy pieces are uniformly distributed by a discharge distributor 55 from the feed port onto a belt conveyor 51; next, the candy pieces are conveyed by the belt conveyor 51 into the vacuum microwave device 52; further, the candy pieces are conveyed downward layer by layer by a conveying device 521 in the vacuum microwave device 52; and when the candy pieces are conveyed downward layer by layer, they are dried by a microwave apparatus 522.

Specifically, the cut candy pieces are conveyed by the belt to the automatic feeding device 50 including two buffer tanks, where the candy pieces are lifted by the belt and alternately distributed into the two buffer tanks through a switching device. The switching operation is performed once every 5 minutes. When one buffer tank is fully loaded, its upper valve is closed while its lower valve is opened, allowing the candy pieces to drop into the feed inlet of the vacuum microwave device 52. Then, the discharge distributor 55 distributes the candy pieces on the belt of the belt conveyor 51. Once the buffer tank is emptied, upon reaching the switching time, the lower valve is closed while the upper valve is reopened to receive new candy pieces. The two buffer tanks alternately feed the drying system 5 in sequence to ensure the vacuum degree of the system. A first moisture detection sensor 53 detects an initial moisture content of incoming candy pieces, and corresponding process parameters, such as vacuum microwave settings of each section, are automatically selected based on the detected moisture content. The candy pieces on the conveying device 521 are conveyed downward layer by layer and dried, and finally reach the discharge port. A second moisture detection sensor 54 at a rear section of the discharge port detects a moisture content of the candy pieces at the discharge port.

S7: operating an oil coating and packaging system 6: receiving the candy pieces continuously discharged from the drying system 5, coating the candy pieces with oil, and packaging oil-coated candy pieces.

Specifically, the dried candy pieces are discharged and conveyed by the belt to an oil coating machine 60 of the oil coating and packaging system 6. After oil coating, the candy pieces are continuously discharged and, after being subjected to light inspection by an inspection light 62, are packaged by a subsequent packaging machine 61.

The present invention has the following beneficial effects:
1. the fully automated gummy candy production system integrates the control system 7, the slurry preparation system 1, the continuous deaeration system 2, the flat sheet pouring system 3, the automatic cutting system 4, the drying system 5, and the oil coating and packaging system 6 to achieve full automation and intelligent production of gummy candies; the production process is simplified and highly continuous, significantly improving production efficiency and drastically reducing production time which is controlled within 8-10 h from feeding the materials to obtaining the final gummy candy products; in addition, the gummy candy production system can operate continuously, and the optimized overall process and equipment reduce factory space requirements and enhance economic benefits;
2. parameter settings in the control system 7 enable easy product changeover and adjustment in the gummy candy production system;
3. when the fully automated gummy candy production system operates integrally, except for those required for material preparation, only 1-2 operators are required to monitor system operation and equipment status, reducing operator workload and achieving labor savings across the entire production line;
4. the integration of the continuous deaerator 21 into the entire production process enables a fully continuous production process, thereby reducing equipment requirements, energy consumption, and product processing time, which achieves both improved gummy candy appearance and continuous production efficiency, and demonstrates unique advantages in producing high-viscosity gelatin-based gummy candies and heat-sensitive functional materials;
5. the vacuum microwave device 52 combines the vacuum cavity 520 and the microwave apparatus 522 therein to accelerate internal moisture migration in the gummy candies, significantly improving drying efficiency and requiring only 4-6 h for the whole drying process. Since the drying operation is carried out in a vacuum environment at a relatively low temperature, it can meet the processing requirements of most heat-sensitive materials. By using a continuous vacuum dryer, it overcomes the technical difficulty of continuously feeding and discharging materials under a vacuum state, and successfully transforms static drying into dynamic drying. The automated programmed control system 7 maintains a good appearance of the gummy candies, greatly improves drying efficiency, and fully reduces the overall production cost; and
6. compared with conventional technologies, the system and method employ a continuous production process, featuring fewer and more streamlined pieces of equipment at the same production scale. The entire production line occupies a smaller footprint, consumes less energy, and reduces production costs while improving labor efficiency, demonstrating unique advantages in producing gelatin-based gummy candies containing functional materials.

The above embodiments only represent several implementation manners of the present invention, and the description thereof is relatively specific and detailed but should not be construed as limiting the scope of the present invention. It should be noted that for those of ordinary skill in the art, several modifications and improvements can be made without departing from the concept of the present invention and these modifications and improvements should all fall within the protection scope of the present invention. Therefore, the protection scope of the present invention shall be subject to the appended claims.

What is claimed is:

1. A gummy candy production system, comprising:
a slurry preparation system (1) for dispersing, dissolving, and shear-mixing continuously supplied materials for preparing a gummy slurry to form a homogeneous gummy slurry, and continuously discharging the gummy slurry at a preset rate;
a continuous deaeration system (2) for receiving and continuously deaerating the gummy slurry continuously discharged from the slurry preparation system (1), and discharging deaerated gummy slurry at a preset rate and temperature;
a flat sheet pouring system (3) for receiving the gummy slurry continuously discharged from the continuous deaeration system (2), and processing the gummy slurry into candy bodies in a fixed shape;
an automatic cutting system (4) for receiving the candy bodies continuously supplied from the flat sheet pouring system (3), and cutting the candy bodies into candy pieces in a preset size;
a drying system (5) for receiving the candy pieces continuously supplied from the automatic cutting system (4), and continuously drying and discharging the candy pieces at a preset rate;
an oil coating and packaging system (6) for receiving the candy pieces continuously discharged from the drying system (5), coating the candy pieces with oil, and packaging oil-coated candy pieces; and
a control system (7) for receiving a product production information instruction and an order quantity, automatically retrieving a product formula, quantities of raw/auxiliary materials, and a production rate, and autonomously retrieving production process parameters of the slurry preparation system (1), the continuous deaeration system (2), the flat sheet pouring system (3), the automatic cutting system (4), the drying system (5), and the oil coating and packaging system (6).

2. The gummy candy production system of claim 1, wherein the slurry preparation system (1) comprises a shear mixing apparatus (10), a plurality of feeding stations (11), a plurality of first heating devices (12), and a plurality of second heating devices (13), wherein the plurality of feeding stations (11) are respectively used for storing materials with different properties and are all connected to the shear mixing apparatus (10) for continuously conveying the materials with different properties to the shear mixing apparatus (10); the shear mixing apparatus (10) is used for continuously dispersing, dissolving, and shear-mixing the materials to form the homogeneous gummy slurry; the control system (7) is electrically connected to the feeding stations (11) for controlling feed rates of the feeding stations (11) and is electrically connected to the shear mixing apparatus (10) for controlling shear rates of screws in the shear mixing apparatus (10); the plurality of first heating devices (12) are all electrically connected to the control system (7) and correspond one-to-one with the plurality of feeding stations (11) to heat the feeding stations (11); and the plurality of second heating device (13) are all electrically connected to the control system (7).

3. The gummy candy production system of claim 1, wherein the continuous deaeration system (2) comprises a feed storage tank (20), a continuous deaerator (21), and a discharge storage tank (22), wherein the feed storage tank (20) is used for temporarily storing the gummy slurry discharged from the slurry preparation system (1); the continuous deaerator (21) is used for receiving and continuously deaerating the gummy slurry supplied from the feed storage tank (20); the discharge storage tank (22) is used for receiving the slurry discharged from the continuous deaerator (21); and the control system (7) is electrically connected to the continuous deaerator (21) for synchronizing a rate at which the continuous deaerator (21) discharges the slurry with that at which the slurry preparation system (1) discharges the gummy slurry.

4. The gummy candy production system of claim 3, wherein the feed storage tank (20) is provided with a pair of first liquid level sensors (200) and a first temperature control device (201), wherein the pair of first liquid level sensors (200) are respectively arranged at high and low level positions in the feed storage tank (20); and both the first liquid level sensors (200) and the first temperature control device (201) are electrically connected to the control system (7);
when a slurry level in the feed storage tank (20) is higher than a level of the first liquid level sensor (200) at the high level position, the control system (7) controls the continuous deaerator (21) to operate continuously at a preset rate; and
when the slurry level in the feed storage tank (20) is lower than a level of the first liquid level sensor (200) at the low level position, the control system (7) controls the continuous deaerator (21) to stop operation.

5. The gummy candy production system of claim 3, wherein the discharge storage tank (22) is provided with a pair of second liquid level sensors (220) and a second temperature control device (221), wherein the pair of second liquid level sensors (220) are respectively arranged at high and low level positions in the discharge storage tank (22); and both the second liquid level sensors (220) and the second temperature control device (221) are electrically connected to the control system (7).

6. The gummy candy production system of claim 5, wherein the flat sheet pouring system (3) comprises a transfer pump (30), an injection device (31), and flat sheet molds (32), wherein the transfer pump (30) is electrically connected to the control system (7) for transferring the slurry from the discharge storage tank (22) to a material storage tank (310) of the injection device (31); the control system (7) is electrically connected to an inner push rod (311) of the injection device (31); and the inner push rod (311) is used for pushing the slurry from the material storage tank (310) into mold cavities (320) of the flat sheet molds (32);
when a slurry level in the discharge storage tank (22) is higher than a level of the second liquid level sensor (220) at the high level position, the transfer pump (30) is started and operates at a preset transfer speed; and
when the slurry level in the discharge storage tank (22) is lower than a level of the second liquid level sensor (220) at the low level position, the transfer pump (30) stops operation.

7. The gummy candy production system of claim 6, wherein the material storage tank (310) is provided with a pair of third liquid level sensors (33), wherein the pair of third liquid level sensors (33) are respectively arranged at high and low level positions in the material storage tank (310); and the third liquid level sensors (33) are electrically connected to the control system (7);
when a slurry level in the material storage tank (310) is higher than a level of the third liquid level sensor (33) at the high level position, the transfer pump (30) stops operation; and
when the slurry level in the material storage tank (310) is lower than a level of the third liquid level sensor (33) at the low level position, the transfer pump (30) is started and operates at a preset transfer speed.

8. The gummy candy production system of claim 6, wherein the flat sheet pouring system (3) further comprises a frame (34), a conveying assembly (35), and a cooling device (36), wherein the conveying assembly (35) comprises a conveyor chain (350) arranged on the frame (34) and a motor (351) for driving the conveyor chain (350); the flat sheet molds (32) are uniformly distributed on the conveyor chain (350); the injection device (31) is arranged at one end of the conveyor chain (350), while the cooling device (36) is arranged at the other end of the conveyor chain (350) for freezing the slurry in the flat sheet molds (32); and the control system (7) is electrically connected to the motor (351) for controlling a running speed of the conveyor chain (350) and is electrically connected to the cooling device (36) for controlling a cooling temperature of the cooling device (36).

9. The gummy candy production system of claim 1, wherein the drying system (5) comprises an automatic feeding device (50), a discharge distributor (55), a belt conveyor (51), and a vacuum microwave device (52), wherein the automatic feeding device (50) is electrically connected to the control system (7) for feeding the candy pieces to a feed port of the vacuum microwave device (52); the discharge distributor (55) is electrically connected to the control system (7) for uniformly distributing the candy pieces from the feed port onto the belt conveyor (51); and the belt conveyor (51) is electrically connected to the control system (7) for conveying the candy pieces into the vacuum microwave device (52); the vacuum microwave device (52) has a vacuum cavity (520) formed therein, and the vacuum cavity (520) is provided with a multi-layer conveying device (521) therein for conveying the candy pieces and a microwave apparatus (522) for providing different microwave heating powers for different layers; and both the conveying device (521) and the microwave apparatus (522) are electrically connected to the control system (7).

10. The gummy candy production system of claim 9, wherein a first moisture detection sensor (53) is arranged at the feed port of the vacuum microwave device (52); a second moisture detection sensor (54) is arranged at a discharge port of the vacuum microwave device (52); and both the first moisture detection sensor (53) and the second moisture detection sensor (54) are electrically connected to the control system (7).

11. The gummy candy production system of claim 1, wherein the oil coating and packaging system (6) comprises an oil coating machine (60), a packaging machine (61), and an inspection light (62), wherein the oil coating machine (60) is electrically connected to the control system (7) for coating dried candy pieces with oil; the inspection light (62) is electrically connected to the control system (7) for performing light inspection on oil-coated candy pieces; and the packaging machine (61) is electrically connected to the control system (7) for packaging light-inspected candy pieces.

12. A gummy candy production method, comprising the following steps:
inputting an instruction: inputting a product production information instruction and an order quantity into a control system (7), wherein the control system (7) automatically retrieves a product formula, quantities of raw/auxiliary materials, a production rate, and production process parameters of each system, and after verification and confirmation, transmits the same to subsequent steps;
operating a slurry preparation system (1): dispersing, dissolving, and shear-mixing continuously supplied materials for preparing a gummy slurry to form a homogeneous gummy slurry, and continuously discharging the gummy slurry at a preset rate;
operating a continuous deaeration system (2): receiving and continuously deaerating the gummy slurry continuously discharged from the slurry preparation system (1), and discharging deaerated gummy slurry at a preset rate and temperature;
operating a flat sheet pouring system (3): receiving the gummy slurry continuously discharged from the continuous deaeration system (2), and processing the gummy slurry into candy bodies in a fixed shape;
operating an automatic cutting system (4): receiving the candy bodies continuously supplied from the flat sheet pouring system (3), and cutting the candy bodies into candy pieces in a preset size;
operating a drying system (5): receiving the candy pieces continuously supplied from the automatic cutting system (4), and continuously drying and discharging the candy pieces at a preset rate; and
operating an oil coating and packaging system (6): receiving the candy pieces continuously discharged from the drying system (5), coating the candy pieces with oil, and packaging oil-coated candy pieces.

13. The gummy candy production method of claim 12, wherein the step of operating the slurry preparation system (1) specifically comprises the following steps:
weighing corresponding weight portions of materials according to the formula and classifying the materials according to their properties, adding the materials into feeding stations (11), and performing temperature control on the materials through first heating devices (12) respectively according to their properties;
calculating and setting, by the system, feed rates of the materials into a shear mixing apparatus (10) according to mass proportions of the materials in total materials;
preheating the shear mixing apparatus (10) through second heating devices (13); and
opening the feeding stations (11), and dispersing, dissolving, and shear-mixing, by the shear mixing apparatus (10), the materials continuously supplied from the feeding stations (11) to form the homogeneous gummy slurry, and continuously discharging the gummy slurry at a preset rate.

14. The gummy candy production method of claim 12, wherein the step of operating the continuous deaeration system (2) specifically comprises the following steps:
feeding the gummy slurry continuously produced by the slurry preparation system (1) into a feed storage tank (20) according to a preset yield; automatically starting a continuous deaerator (21) to operate at a preset deaeration rate and corresponding process parameters when first liquid level sensors (200) in the feed storage tank (20) detect the gummy slurry; and transferring deaerated gummy slurry to a discharge storage tank (22).

15. The gummy candy production method of claim 12, wherein the step of operating the drying system (5) specifically comprises the following steps:
feeding, by an automatic feeding device (50), the candy pieces to a feed port of a vacuum microwave device (52); uniformly distributing, by a discharge distributor (55), the candy pieces from the feed port onto a belt conveyor (51); conveying, by the belt conveyor (51), the candy pieces into the vacuum microwave device (52); conveying, by a conveying device (521) in the vacuum microwave device (52), the candy pieces downward layer by layer; and drying, by a microwave apparatus (522), the candy pieces when they are conveyed downward layer by layer.
